(19) United States
(12) Patent Application Publication
(10) Pub. No.: US 2010/0226582 A1
(43) Pub. Date: Sep. 9, 2010

(54) ASSIGNING LABELS TO IMAGES IN A COLLECTION

(76) Inventors: Jiebo Luo, Pittsford, NY (US); Liangliang Cao, Urbana, IL (US)

Correspondence Address: Raymond L. Owens;Patent Legal Staff, Eastman Kodak Company, 343 State Street, Rochester, NY, 14650-2201, US

(21) Appl. No.: 12/396,642

(22) Filed: Mar. 3, 2009

(51) Int. Cl. G06K 9/62

(52) U.S. Cl. 382/224

(57) ABSTRACT

A method of assigning semantic labels to images in a particular collection, includes acquiring seed labels for a subset of images; propagating the seed labels to other images according to a similarity metric; and storing the semantic labels, including both seed labels and propagated labels with the corresponding images.

### FIELD OF THE INVENTION

The present invention relates to image collections, and more particularly assigning semantic labels to images in the image collection.

### BACKGROUND OF THE INVENTION

In recent years, the popularity of digital cameras has lead to a flourish of personal digital photos. For example, Kodak Gallery, Flickr and Picasa Web Album host millions of new personal photos uploaded every month. Compared with professional image banks such as Corel, these personal photos constitute an overwhelming source of images requiring efficient management. Recognizing and annotating these photos are of both high commercial potentials and broad research interests.

The difficulties in annotating personal photos lie in two aspects. First, such photos are of highly varying qualities, because they were taken by different people with different photography skills in different conditions. In contrast, the images in the Corel dataset were taken by professionals and thus share similarly well-controlled exposure conditions. Second, personal photos are far more complex in terms of semantic meaning. While Corel images are categorized in well-defined object and scene classes, personal photos contain unconstrained content and often are records of people, places, and events. All these factors pose greater changes for annotation, search and retrieval tasks.

Using a computer to analyze and discern the meaning of the content of digital media assets, known as semantic understanding, is an important field for enabling the creation of an enriched user experience with these digital assets.

One type of understanding in the digital imaging realm is identifying the type of scene that a photo captures, such as beach, mountain, field, desert, urban, rural and so on. Another type of semantic understanding is the analysis that leads to identifying the type of event that the user has captured such as a birthday party, a baseball game, a concert and many other types of events where images are captured. In general, scene labels and event labels mentioned about are referred to as semantic labels. Typically, semantic labels such as these are recognized using a probabilistic graphic model that is learned using a set of training images to permit the computation of the probability that a newly analyzed image is of a certain scene or event type. An example of this type of model is found in the published article of L.-J. Li and L. Fei-Fei, What, where and who? Classifying event by scene and object recognition, Proceedings of ICCV, 2007.

While existing art has focused on using pictorial information within a photo in order to classify scenes and events for photos in a one by one, once and for all manner, one distinct but often overlooked feature of personal photos is that they are usually organized into collections or albums by time, location, and events. Since the users always move their photos from the camera to a computer, the photos are inevitably separated into file folders according to different dates. When the users want to share the photos with their friends, a natural and also informative way is to group the photos by location and date. The photos within the same file folder are often closely correlated to each other, since they were likely to be taken at the same time, place or event. This characteristic does not hold for generic image datasets.

There is then a need as well as possibility to use the folder organization to improve the annotation of diverse personal photos within the context of photo collections.

### SUMMARY OF THE INVENTION

In accordance with the present invention, there is a method of assigning semantic labels to images in a particular collection, comprising:

(a) acquiring seed labels for a subset of images;

(b) propagating the seed labels to other images according to a similarity metric; and

(c) storing the semantic labels, including both seed labels and propagated labels, with the corresponding images.

Features and advantages of the present invention include more accurate assignment of semantic label to images in a collection over directly assigning semantic labels once and for all to individual images. These semantic labels can be used for searching or organizing images or image collections.

### BRIEF DESCRIPTION OF THE DRAWINGS

FIG. 1 is pictorial of a system that can make use of the present invention;

FIG. 2 is a table showing an ontological structure of example event labels;

FIG. 3 is a flow chart for practicing an embodiment of the invention; and

FIGS. 4a and 4b depict two main types of image similarity measures used for enabling the invention.

### DETAILED DESCRIPTION OF THE INVENTION

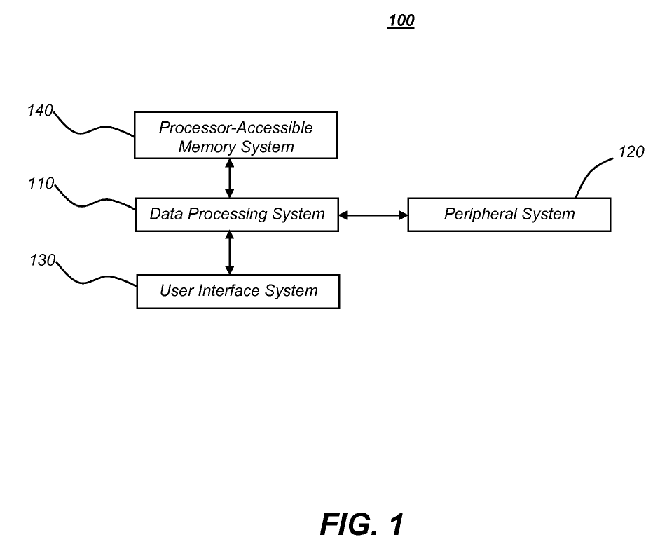

FIG. 1 illustrates a system 100 for assigning semantic labels to photos, according to an embodiment of the present invention. The system 100 includes a data processing system 110, a peripheral system 120, a user interface system 130, and a processor-accessible memory system 140. The processor-accessible memory system 140, the peripheral system 120, and the user interface system 130 are communicatively connected to the data processing system 110.

The data processing system 110 includes one or more data processing devices that implement the processes of the various embodiments of the present invention, including the example processes of FIG. 1. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device or component thereof for processing data, managing data, or handling data, whether implemented with electrical, magnetic, optical, biological components, or otherwise.

The processor-accessible memory system 140 includes one or more processor-accessible memories configured to store information, including the information needed to execute the processes of the various embodiments of the present invention. The processor-accessible memory system 140 can be a distributed processor-accessible memory system including multiple processor-accessible memories communicatively connected to the data processing system 110 via a plurality of computers or devices. On the other hand, the processor-accessible memory system 140 need not be a distributed processor-accessible memory system and, consequently, can include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMs.

The phrase “communicatively connected” is intended to include any type of connection, whether wired or wireless, between devices, data processors, or programs in which data can be communicated. Further, the phrase “communicatively connected” is intended to include a connection between devices or programs within a single data processor, a connection between devices or programs located in different data processors, and a connection between devices not located in data processors at all. In this regard, although the processor-accessible memory system 140 is shown separately from the data processing system 110, one skilled in the art will appreciate that the processor-accessible memory system 140 can be stored completely or partially within the data processing system 110. Further in this regard, although the peripheral system 120 and the user interface system 130 are shown separately from the data processing system 110, one skilled in the art will appreciate that one or both of such systems can be stored completely or partially within the data processing system 110.

The peripheral system 120 can include one or more devices configured to provide digital images to the data processing system 110. For example, the peripheral system 120 can include digital video cameras, cellular phones, regular digital cameras, or other data processors. The data processing system 110, upon receipt of digital content records from a device in the peripheral system 120, can store such digital content records in the processor-accessible memory system 140.

The user interface system 130 can include a mouse, a keyboard, another computer, or any device or combination of devices from which data is input to the data processing system 110. In this regard, although the peripheral system 120 is shown separately from the user interface system 130, the peripheral system 120 can be included as part of the user interface system 130.

The user interface system 130 also can include a display device, a processor-accessible memory, or any device or combination of devices to which data is output by the data processing system 110. In this regard, if the user interface system 130 includes a processor-accessible memory, such memory can be part of the processor-accessible memory system 140 even though the user interface system 130 and the processor-accessible memory system 140 are shown separately in FIG. 1.

In essence, photo collections provide rich information beyond the sum of individual photos. One can assume that the photos in the same collection are taken by the same person using the camera under similar capture conditions. Under such an assumption, if two consecutive photos share similar visual features, it is likely that they describe the same scene or event. This is a powerful context that would not exist for general photos, which can describe different semantic content even if they contain similar color of texture features. In other words, the “semantic gap” in image similarity matching is inherently limited with the same photo collection. Moreover, computing the similarity among all possible image pairs in a large database would be time consuming, while the computation for image pairs within a photo collection involves fewer photos that are already ordered in time and even location (when GPS coordinates are available, GPS stands for Global Positioning System).

One can also model the photo similarity using metadata information such as timestamp and GPS tags. Every JPEG image file records the date and time when the photo was taken. An advanced camera can even record the location via a GPS receiver. However, due to the sensitivity limitation of the GPS receiver, GPS tags can be missing (especially for indoor photos). Since the photos in a collection are taken by the same camera, one can estimate whether labels of two photos are the same by the time and GPS information, either independent of or in conjunction with visual features. When the two photos are taken in a short time interval, it is unlikely that the scene or event labels change. Similarly, when two photos location does not change, the photos probably describe the same scene and event. Such metadata information was often overlooked in previous annotation work until Boutell and Luo, Beyond pixels: Exploiting camera metadata for photo classification. Pattern Recognition 38(6): 935-946, 2005. The present invention shows that they are also useful for propagating labels in the same photo collection.

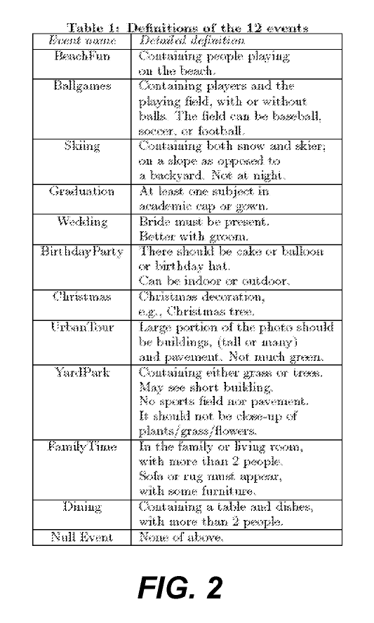

In an embodiment of the present invention, an ontology of 12 events and 12 scenes form the set of semantic labels used to annotate photos. Note that the 12 events include a null category for “none of the above”, such that the present invention can also handle the collections that are not of high interest. This is an important feature for a practical system. Consequently, each photo can be categorized into one and only one of these mutually-exclusive events. The definitions of the event labels are given in FIG. 2. Each image can also be assigned with the scene labels using the same class definitions by Fei-Fei and Perona, A Bayesian hierarchical model for learning natural scene categories, Proceedings of CVPR 2005: coast, open-country, forest, mountain, inside-city, suburb, highway, livingroom, bedroom, office, and kitchen. In a preferred embodiment of the present invention, that inside-city includes the three original classes of inside-city, street and tall-building, since these three classes that are visually and semantically similar. Again, a null scene class can be added to handle any unspecified cases.

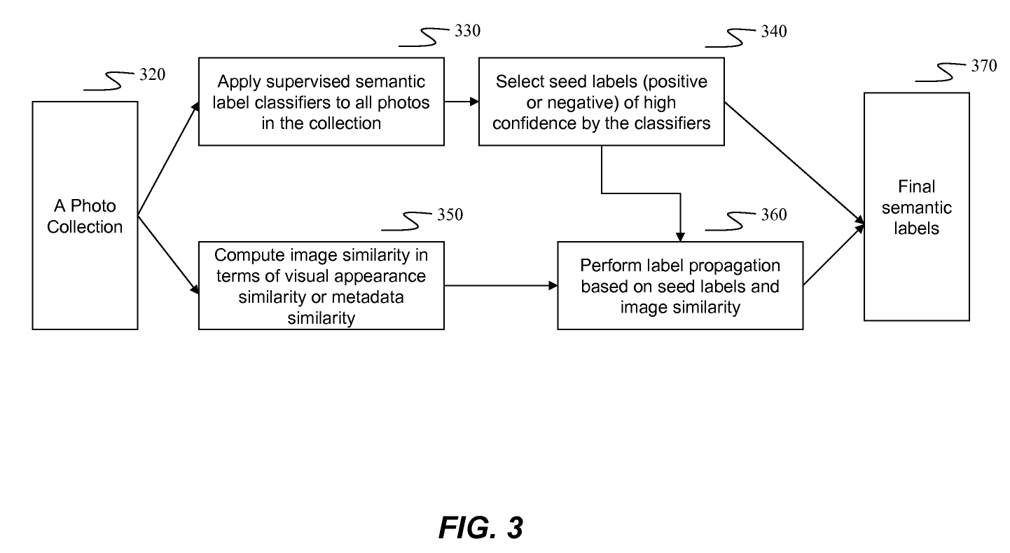

In FIG. 3, a process diagram is illustrated showing the sequence of steps necessary to practice the invention. For a given photo collection 320, a suite of pre-trained semantic label classifiers (for scenes and events) is first applied 330 to each image in the collection. Based on the confidence values of the classifiers, a plurality of seed labels with confidence values above pre-determined thresholds are selected 340, including both positive and negative labels. Labels with confidence values below the thresholds are rejected and discarded. Next, image similarity measures are computed 350, in terms of appearance similarity or metadata similarity or any combination. Label propagation is performed in block 360 based on the seed labels and the computed image similarity to images whose labels have been rejected earlier. The final semantic labels 370 are the union of both the seed labels and propagated labels, which are stored with the corresponding images. More details are described in the following.

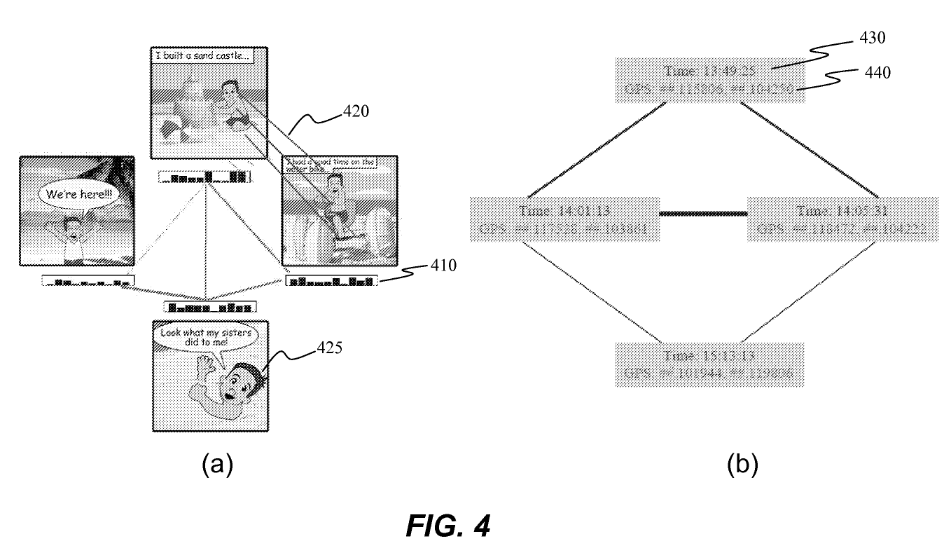

Referring to FIG. 4, a number of image similarity measures can be used individually or in combine to facilitate label propagation. Most existing work typically model the similarity between two images using low-level visual features, for example, J. Liu, M Li, W. Y. Ma, Q. Liu, H. Lu, An adaptive graph model for automatic image annotation, ACM workshop on Multimedia Information Retrieval, 2006. Due to the well-known gap between high-level semantics and low-level features, many images with different semantic content can share similar visual features, which suggest that it is beneficial to employ other sources of features to model the photo similarity. To model the photo correlation within the same collection, the present invention employs both low level color features and scale invariant structure features (SIFT, see D. Lowe, Distinctive Image Features from Scale-Invariant Keypoints, 60(2): 91-110, International Journal of Computer Vision, 2004), together with the metadata features such as time and location. Briefly, the SIFT features are based on the appearance of the object at particular interest points, and are invariant to image scale and rotation. The metadata features are well suited for personal photo annotations, but not so for analyzing single photos. For example, for photos with close timestamps in the same personal photo collection, one can expect the photos to be semantically related to each other. However, if the two photos are taken by different people, most likely they are uncorrelated even if they were taken in the same time.

Two types of visual features can be used to model pair-wise similarities between consecutive images. The first type are visual appearance features, including low level color features and SIFT features, as shown in FIG. 4a. The second type corresponds to metadata features, e.g., time and GPS, as shown in FIG. 4b.

There are many forms of low level visual features, such as color, texture, and shape features. A color histogram 410 is computed in the LAB space for each photo, and the correlation between two color histograms is used to model visual similarity.

Due to the recent advance in object recognition, one can employ the SIFT features together with the low level color features to model the visual similarity. SIFT is well suited for matching the same object in different images, and has shown effectiveness in image alignment and panoramic reconstruction. Within the same photo collection, it is expected that neighboring photos contain a common subject. Note that this matching task is more restricted than general object recognition, which requires a codebook or vocabulary obtained by extensive training processes. In contrast, the matching in the present invention is much faster. Given two photos, they are considered as two sets of SIFT features. For each SIFT feature, two matching SIFT features are found in the other image, i.e., those with the highest and the second highest correlation. If the ratio of two correlation values is above a threshold (e.g., 1.2), it is decided that one pair of matching SIFT features 420 are found. The more correspondent SIFT features are found, the more similar the two photos are.

In addition to low-level visual features, high-level features such as matching faces 425, clothing, or other objects can be used to relate images in the same collection. Face recognition and object recognition are well known in the art. One can also employ metadata to model the similarity between two photos in a collection. Consider two kinds of metadata features, a time stamp 430 and a GPS coordinates 440. By the time features, the similarity between two photos is measured by the interval between the moments when the photos were taken. By the GPS features, the similarity is measured by the distance between the locations where the photos were taken. Such metadata information provides useful information for photo annotation. For example, if the user took photos near the beach, it is unlikely that he could move to inside the city within 5 minutes. Moreover, if the GPS tags show that the user moved only a few meters, the possibility that the user moved from mountain to indoors is extremely low. In short, if two consecutive photos are close in time and location, they tend to share the same labels.

For the annotation task, the present invention builds a generative model for both modeling the image similarities and propagating the labels. The reason for developing a probabilistic model is three fold. First, it is nontrivial to combine diverse evidences measured by different ways and represented by different metrics. For example, color similarities are represented by histogram correlations, and the subject similarity based on SIFT features is represented by integer numbers. Similarities by time and location are measured by minutes and meters, respectively. A probabilistic evidence fusion framework would permit all the information to be integrated in common terms of probabilities. Second, probabilistic models are capable of handling incomplete information gracefully. Such properties are crucial especially for location features, since GPS tags sometimes can be missing due to the sensitivity limitation of the GPS receiver. Last but not the least, a probabilistic model can fully characterize the interacting effects from both positive and negative evidences, and estimate the true probability of each sample. Negative evidence is a unique feature of the present invention, as now it becomes possible to propagate the fact that one image is not in a particular class to its neighbors. This is also useful in practice because the concept classifiers can provide both positive (that the image is of class A) and negative (that the image is not of class B). It is also possible for a user to provide both positive and negative initial labels, similar to relevance feedback where both positive and negative feedback are valuable.

Following the standard practice in concept detection, in one embodiment of the present invention, a suite of pre-trained SVM classifiers are used for both event and scene classes. Although such classifiers cannot classify every photo correctly, one can select those labels with high confidence scores and treat the labels generated by the SVM classifiers as the initialization, or seeds, for label propagation. Because both positive and negative evidences are used in the present invention, in a preferred embodiment of the present invention, the labels with scores below the threshold of −1.0 are selected as negative initial evidence, and the labels with scores above the threshold of 0.2 are selected as positive initial evidence.

Given two photos i and j, denote the label variables as yᵢ and yⱼ. To model the similarity between photo i and j, given photo features xᵢ, xⱼ, their similarity is measured by dᵢⱼ=Similarity(xᵢ, xⱼ).

To measure whether two images are correlated or not, a new variable is introduced for modeling the correlation between image i and j, which is defined as

$${s}_{ij} = \{ \begin{matrix}1 & if {y}_{i} = {y}_{j} \\ 0 & if {y}_{i} \neq {y}_{j}\end{matrix} . \qquad ( 1 )$$

Note that here the photo label y is not modeled directly. Instead, the present invention uses the appearance and metadata features to model s_{ij,} which characterizes whether the two photo labels are similar. Now one can model the probability of image correlation by P(sᵢⱼ|dᵢⱼ). Using the Bayesian formula,

$$P ( {s}_{ij} = δ \vert {d}_{ij} ) = \frac{P ( {d}_{ij} \vert {s}_{ij} = δ ) P ( {s}_{ij} = δ )}{{\sum }_{{δ}_{1} = \{ 0 , 1 \}} P ( {d}_{ij} \vert {s}_{ij} = {δ}_{1} ) P ( {s}_{ij} = {δ}_{1} )} \qquad ( 2 )$$

The probabilistic formulation of Eq. (2) can be easily learned from the data. Another benefit of Eq. (2) is that it provides a good frame work to introduce multiple features. When each image is associated with multiple visual and metadata features, they are denoted by xᵢ={xᵢ^{k}} and xⱼ={xⱼ^{k}}, where 1≦k≦K denotes the feature type. Now the similarity dᵢⱼ is represented by dᵢⱼ=dᵢⱼ^{k}, and each dᵢⱼ^{k} measures the similarity between xᵢ^{k} and xⱼ^{k}. Now one can model the conditional similarity as

$$P ( {d}_{i , j} \vert {s}_{ij} ) = {\prod }_{k = 1}^{K} P ( {d}_{ij}^{k} \vert {s}_{i , j} , {d}_{ij}^{1} , … , {d}_{ij}^{k - 1} ) \qquad ( 3 )$$

To make the computation efficient, it is assumed that different types of features are conditionally independent given sᵢⱼ, i.e.,

$$P ( {d}_{i , j} \vert {s}_{ij} ) = {\prod }_{k} P ( {d}_{ij}^{k} \vert {s}_{i , j} ) \qquad ( 4 )$$

By combining Eqs. (2) and (4), the correlation probability P(sᵢⱼ|dᵢⱼ) is determined.

This probabilistic model can handle the partially missing GPS without difficulty. Suppose one feature k⁰ is missing, then Eq. (1) becomes

$$P ( {s}_{ij} = δ \vert {d}_{ij} ) = \frac{{\prod }_{k \neq {k}^{0}} P ( {d}_{ij}^{k} \vert {s}_{ij} = δ ) P ( {s}_{ij} = δ )}{{\sum }_{{δ}_{1} = \{ 0 , 1 \}} {\prod }_{k \neq {k}^{0}} P ( {d}_{ij} \vert {s}_{ij} = {δ}_{1} ) P ( {s}_{ij} = {δ}_{1} )}$$

To make the representation simpler to follow, a two-class problem is described. For each task, one aims to infer the label y for each image, where yᵢ=1 means an image should be assigned to the label, and yᵢ=0 means it should not be assigned the label. The probability of image labels satisfies the constraint

P(yᵢ=1)+P(yᵢ=0)=1.

Using the initialization method described earlier, a set L of labeled images is obtained, where P(yᵢ=1)=1 or P(yᵢ=0)=1 if i ε L. The other images belong to the set of unlabeled images U, where P(yᵢ=1)=P(yᵢ=0)=0.5 for i ε U.

Based on the early discussion, one can estimate the probability of label propagation using the correlation probability P(sᵢⱼ|dᵢⱼ)

P(yᵢ→yⱼ)=λᵢ·P(sᵢⱼ=1|dᵢⱼ) (5)

where λᵢ is a normalization constant satisfying

$${λ}_{i} = 1 / {\sum }_{k \neq i} P ( {s}_{ik} = 1 \vert {d}_{ik} )$$

In the present invention, each unlabeled photo j ε U updates its probability by considering label probability of the other photos which are similar by any measure. There are two possible labels, y=0 or y=1, which can be computed separately.

$${P}_{j}^{+} = {\sum }_{i \neq j} P ( {y}_{i} = 1 ) P ( {y}_{i} -> {y}_{j} ) \\ {P}_{j}^{-} = {\sum }_{i \neq j} P ( {y}_{i} = 0 ) P ( {y}_{i} -> {y}_{j} ) \qquad ( 6 )$$

Note that the updated probability does not satisfy the constraint of P(yᵢ=1)+P(yᵢ=0)=1. There is a need to normalize them after each updating stage.

$$P ( {y}_{j} = 1 ) ← \frac{{P}_{j}^{+}}{{P}_{j}^{-} + {P}_{j}^{+}} \\ P ( {y}_{j} = 0 ) ← \frac{{P}_{j}^{-}}{{P}_{j}^{-} + {P}_{j}^{+}} \qquad ( 7 )$$

Since there is high confidence in the labeled set L, the present invention only updates the probability for j ε U. In each iteration, the probability for every unlabeled photo is updated using (6) and (7). This procedure continues until it converges or reaches a maximum number of iterations (e.g., 100).

A preferred embodiment of the propagation algorithm is summarized as follows:

```
Input: Pairwise image similarity dᵢⱼ. Initialized photo set
  L with the labels yᵢ = l or yᵢ = 0, for i ∈ L.
Output: The estimated labels of photos in the unlabeled
  set U.
Procedure:
    1. Estimate the correlation probability P(sᵢⱼ|d_{i,j})
      according to eqs. (3) and (5).
    2. Obtain propagation probability P(yᵢ → yⱼ) by
      normalizing P(sᵢⱼ|dᵢⱼ) using eq. (6)
    3. Initialize P(yᵢ = 1) = 1 or P(yᵢ = 0) = 1 if
      i ∈ L. Initialize P(yⱼ = 1) = P(yⱼ = 0) = 0.5 for
      j ∈ U.
    4. For each unlabeled photo j ∈ U, update P(yⱼ)
      using eqs. (7) and (8).
    5. Repeat step 4 until it converges or reaches a
      maximum number of iterations.
    6. Assign yⱼ = 1 if P(yⱼ = 1) > 0.5. Otherwise let
      yⱼ = 0.
```

The present invention can be easily generalized to a multi-label problem by treating it as multiple two-class problems. If no more than one label is permitted for each image, one simply selects the one with the largest probability of P(yⱼ=1).

The various embodiments described above are provided by way of illustration only and should not be construed to limit the invention. Those skilled in the art will readily recognize various modifications and changes that can be made to the present invention without following the example embodiments and applications illustrated and described herein, and without departing from the true spirit and scope of the present invention, which is set forth in the following claims.

PARTS LIST

| | |
|---|---|
| 100 | system |
| 110 | data processing system |
| 120 | peripheral system |
| 130 | user interface system |
| 140 | processor-accessible memory system |
| 320 | photo collection |
| 330 | step: apply supervised semantic label classifiers to all photos in |
| | the collection |
| 340 | step: select seed labels of high confidence by the classifiers |
| 350 | step: compute image similarity |
| 360 | step: perform label propagation |
| 370 | final semantic labels |
| 410 | color histogram |
| 420 | matching SIFT features |
| 425 | matching faces |
| 430 | time stamp |
| 440 | GPS coordinates |

1. A method of assigning semantic labels to images in a particular collection, comprising:
(a) acquiring seed labels for a subset of images;
(b) propagating the seed labels to other images according to a similarity metric; and
(c) storing the semantic labels, including both seed labels and propagated labels, with the corresponding images.

2. The method of claim 1 wherein the seed labels are acquired at least in part from a user.

3. The method of claim 1 wherein the similarity metric includes visual similarity or metadata similarity, or combinations thereof.

4. The method of claim 3 wherein the visual similarity is computed based on color histogram, or SIFT features, or combinations thereof.

5. The method of claim 3 wherein the metadata similarity is computed based on timestamp, or GPS coordinates, or combinations thereof.

6. The method of claim 1 wherein the stored semantic labels are used for searching or organizing images or image collections.

7. The method of claim 1 wherein the semantic label is either positive or negative evidence.

8. The method of claim 1 wherein the label propagation step comprises:
(i) estimating the probability of label propagation from one photo to another using a correlation probability;
(ii) updating each unlabeled photo with respect to its probability by considering label probability of the other photos which are similar by a similarity measure; and
(iii) repeating this procedure until it converges, or reaches a predetermined maximum number of iterations.

9. A method of assigning semantic labels to images in a particular collection, comprising:
(a) analyzing the images in the collection using a set of predetermined semantic label classifiers to produce semantic labels with associated confidence values for each semantic label for each image;
(b) retaining only semantic labels for each image with confidence above a selected value as seed labels and discarding remaining semantic labels;
(c) propagating the seed labels to other images according to a similarity metric; and
(d) storing the semantic labels, including both seed labels and propagated labels, and the corresponding images.

10. The method of claim 9 wherein the seed labels are acquired at least in part from a user.

11. The method of claim 9 wherein the similarity metric includes visual similarity or metadata similarity, or combinations thereof.

12. The method of claim 11 wherein the visual similarity is computed based on color histogram, or SIFT features, or combinations thereof.

13. The method of claim 11 wherein the metadata similarity is computed based on timestamp, or GPS coordinates, or combinations thereof.

14. The method of claim 9 wherein the stored semantic labels are used for searching or organizing images or image collections.

15. The method of claim 9 wherein the semantic label is either positive or negative evidence.

16. The method of claim 9 wherein the label propagation step comprises:
(i) estimating the probability of label propagation from one photo to another using a correlation probability;
(ii) updating each unlabeled photo with respect to its probability by considering label probability of the other photos which are similar by a similarity measure; and
(iii) repeating this procedure until it converges, or reaches a predetermined maximum number of iterations.
